(19) United States
(12) Patent Application Publication
(10) Pub. No.: US 2023/0400079 A1
(43) Pub. Date: Dec. 14, 2023

(54) METHOD AND CONTRUCTION KIT FOR PRODUCING A LEAF SPRING APPARATUS MANUFACTURED FROM A FIBRE COMPOSITE PLASTIC

(71) Applicant: Rheinmetall Invent GmbH, Neuss (DE)

(72) Inventors: Ingo Goutier, Bad Rappenau (DE); Martin Weissert, Nordheim (DE); Jan Foerster, Neckarsulm (DE); Dennis Blank, Neckarsulm (DE)

(73) Assignee: Rheinmetall Invent GmbH, Neuss (DE)

(21) Appl. No.: 18/033,277

(22) PCT Filed: Oct. 22, 2021
(86) PCT No.: PCT/EP2021/079418

§ 371 Date: Apr. 21, 2023

(30) Foreign Application Priority Data
Oct. 22, 2020 (DE) 10 2020 127 870.5

(51) Int. Cl. F16F 1/368

(52) U.S. Cl. CPC F16F 1/368; F16F 2226/04

(57) ABSTRACT

A method for manufacturing a leaf spring device (1) made from a fiber composite plastic, comprising the following steps: a) providing (S1) a construction kit (11) comprising a leaf spring unit (2) made from the fiber composite plastic and a plurality of stiffening elements (8, 8A, 8A′, 8A″, 8B, 8B′, 8B″, 8C, 8C′) for locally stiffening the leaf spring unit (2), b) designing (S2) the leaf spring device (1) according to a desired application, c) selecting (S3) stiffening elements (8, 8A, 8A′, 8A″, 8B, 8B′, 8B″, 8C, 8C′) from the construction kit (11) according to the design of the leaf spring device (1), and d) combining (S4) the selected stiffening elements (8, 8A, 8A′, 8A″, 8B, 8B′, 8B″, 8C, 8C′) and the leaf spring unit (2) to form the leaf spring device (1).

### CROSS-REFERENCE TO RELATED APPLICATIONS

This application is for entry into the U.S. National Phase from which priority is claimed under all applicable sections of Title 35 of the United States Code including, but not limited to, Sections 120, 363, and 365(c) to International Application Serial No. PCT/EP2021/079418, filed on Oct. 22, 2021 and entitled “METHOD AND CONSTRUCTION KIT FOR PRODUCING A LEAF SPRING APPARATUS MANUFACTURED FROM A FIBRE COMPOSITE PLASTIC,” which in turn claims priority to German Patent Application Serial No. DE 10 2020 127 870.5, filed on Oct. 22, 2020 and entitled “VERFAHREN AND BAUKASTEN.” Each of International Application Serial No. PCT/EP2021/079418 and German application Serial No. DE 10 2020 127 870.5 is incorporated by reference herein in its entirety.

### FIELD OF THE INVENTION

The present invention relates to a method for manufacturing a leaf spring device made of a fiber composite plastic, and to a construction kit for manufacturing such a leaf spring device.

### BACKGROUND

In motor vehicles, springs may be provided in the chassis for spring mounting of the motor vehicle. Such springs are usually made of metal materials and are therefore heavy and susceptible to corrosion. Springs made of fiber composite plastics are lighter and less susceptible to corrosion, but are more complex in terms of their design and manufacture. Composite leaf springs in particular are increasingly replacing steel leaf springs in the automotive sector due to their simpler design compared to steel coil springs, and represent a disruptive technology compared to steel leaf springs that can be increasingly established with mastered manufacturing processes. An attractive concept for substituting steel coil springs are bending springs made of fiber composite plastics. Manufacturing concepts already exist for such bending springs. However, these are economically uninteresting because they are too expensive.

In the field of vehicle chassis in particular, a wide variety of variants of a spring are required, especially for high-volume vehicle platforms, for example in the order of several million motor vehicles, since a vehicle platform is intended to serve different vehicle models and configurations. That is, the suspension is different for different weight classes, for example, due to different motorization, heights of the body, application purposes, such as sport or comfort version or the like. Accordingly, a wide variety of spring variants are required. In the case of steel springs, these variants can be produced without significant additional costs, as their shaping is carried out using the freehand method, i.e. they are not bound to tools.

Coil springs made of fiber composite plastics have too low performance due to the anisotropic material properties of fiber composite plastics with too low lightweight effect and too complex manufacturing processes. Bending springs made of fiber composite plastics, on the other hand, have too high a stress load, especially at an inner radius of deflection sections of the zigzag-shaped bending spring, which can lead to limited performance or breakage. The applicant is aware of in-house prior art in which these aforementioned deflection sections are stabilized. The spring action is then performed purely by leaf spring sections which are firmly connected to each other at the deflection sections.

However, the aforementioned concepts have a too complex manufacturing process to be economically interesting as a mass product. With regard to the production of variants, steel springs are advantageous because they do not require a tool and, due to the mastered manufacturing processes, can be easily designed and economically produced even in small quantities. Springs made of fiber composites, on the other hand, are tool-bound. This means that a separate tool usually has to be built for each spring size, load capacity or similar in order to be able to produce this spring. With a high production volume per vehicle platform, the tooling costs per spring increase despite the high total number of units. At the same time, the batch size falls and the complexity and number of configurations increase. The economic efficiency decreases strongly with the number of variants.

Against this background, one object of the present invention is to provide an improved method for manufacturing a leaf spring made from a fiber composite plastic.

### SUMMARY OF THE DISCLOSURE

Accordingly, a method for manufacturing a leaf spring device made from a fiber composite plastic is proposed. The method comprises the steps of: a) providing a construction kit comprising a leaf spring unit made from the fiber composite plastic and a plurality of stiffening elements for locally stiffening the leaf spring unit, b) designing the leaf spring device according to a desired application, c) selecting stiffening elements from the construction kit according to the design of the leaf spring device, and d) combining the selected stiffening elements and the leaf spring unit to form the leaf spring device.

Since the leaf spring device can be manufactured on the basis of a construction kit which requires only a limited number of different stiffening elements, it is possible to produce a large number of different leaf spring devices at low cost and with little effort. Small series can also be produced at low cost.

The fiber reinforced plastic (FRP) may also be referred to as fiber reinforced plastic material. The fiber reinforced plastic comprises a plastic material, in particular a plastic matrix, in which fibers, for example natural fibers, glass fibers, carbon fibers, aramid fibers or the like are embedded. The plastic material may be a thermoset, such as an epoxy resin. The fibers may be continuous fibers. However, the fibers may also be short or medium length fibers, which may have a fiber length of a few millimeters to a few centimeters. The fibers may be arranged directionally or non-directionally in the plastic material. The leaf spring unit may have a layered or laminated structure. For this purpose, for example, layers of fiber fabric or fiber scrim are impregnated with the plastic material. Alternatively, however, so-called prepregs, i.e. pre-impregnated fibers, fiber fabrics or fiber scrims, can be used to manufacture the leaf spring unit.

In the present context, a “leaf spring unit” is to be understood as a spring or spring element which is constructed from a plurality of leaf spring elements or leaf spring sections which are connected to one another and thus preferably form a zigzag or meander-shaped geometry. The individual leaf spring sections may have a leaf-shaped or plate-shaped geometry. “Leaf-shaped” or “plate-shaped” does not, however, preclude the leaf spring sections from being curved or of any three-dimensional shape. In contrast to the leaf spring unit, a cylindrical spring or coil spring has a continuous wire which is helically shaped such that the coil spring has a cylindrical geometry. Preferably, the leaf spring device is a compression spring. However, the leaf spring device may also be a tension spring.

The leaf spring unit is preferably a bending spring or bending spring unit or can be designated as such. A “bending spring” or “bending spring unit” in the present context means a component, in the simplest case a rod-shaped bending beam, which deforms resiliently and thus reversibly under load. The material properties of the material used and the geometry of the leaf spring unit influence its deformation behavior.

The leaf spring device differs from the leaf spring unit in that the leaf spring device comprises both the leaf spring unit and the stiffening elements. That is, the leaf spring unit and the stiffening elements are part of the leaf spring device. The stiffening elements, on the other hand, are not part of the leaf spring unit. However, this does not preclude the stiffening elements from being attached or secured to the leaf spring unit. The leaf spring device may comprise a plurality of leaf spring units.

In the present case, the fact that the leaf spring device is made of the fiber composite plastic does not preclude that the leaf spring device also comprises other materials. In the present context, “stiffness” is to be understood as the resistance of the leaf spring unit to elastic deformation. That is, the stiffening elements are arranged to influence the leaf spring unit in such a way that its resistance to elastic deformation is changed, in particular increased. “Locally” in this context means that the leaf spring unit is stiffened only in specific sections, namely in the sections in which the stiffening elements are provided.

In providing the construction kit, preferably a plurality of leaf spring units are manufactured. Preferably, the leaf spring units are identical. Accordingly, a plurality of stiffening elements are also manufactured. The construction kit may comprise any number of different stiffening elements. The design of the leaf spring device can be carried out, for example, with the aid of a computer program. However, this is not absolutely necessary. The desired application may be, for example, a particular type of vehicle manufactured in different configurations. For each of the configurations of the motor vehicle, an individual leaf spring device can be manufactured with the aid of the construction kit.

The stiffening elements are selected on the basis of the design. That is, during the design of the leaf spring device, for example, its geometry, its spring deflection and/or its spring constant are determined or calculated. Based on this data, the suitable stiffening elements are selected from the construction kit and subsequently combined with the leaf spring unit to form the leaf spring device. In the present context, “combining” is to be understood as meaning that the stiffening elements are attached to specific areas of the leaf spring unit. For this purpose, the stiffening elements can, for example, be glued to the leaf spring unit.

According to one embodiment, in step d), the selected stiffening elements are attached to deflection sections of the leaf spring unit.

As previously mentioned, the leaf spring unit preferably comprises a plurality of elastically deformable leaf spring sections. The leaf spring sections are connected to each other by means of the deflection sections. That is, the leaf spring unit is deflected at the deflection sections, in particular by 180° in each case. This results in the zigzag or meander-shaped structure of the leaf spring unit. In particular, the stiffening elements stiffen the deflection sections. Through this, the deflection sections have a higher stiffness compared to the leaf spring sections, whereby only the leaf spring sections and not the deflection sections are deformed when the leaf spring device is loaded. In particular, this prevents critical compressive stresses from occurring in the deflection sections, especially on inner radii of the deflection sections, which could damage the leaf spring unit.

According to a further embodiment, in step d), the selected stiffening elements are attached to a respective inner radius of the deflection sections.

In particular, each deflection section has an outer radius and the inner radius. A stiffening element is provided at each of the inner radius. In this regard, a stiffening element may be provided at each deflection section of the leaf spring unit. Alternatively, stiffening elements may be provided only at selected deflection sections of the leaf spring unit.

According to a further embodiment, in step d), the selected stiffening elements are connected to the deflection sections in a form-fitting and/or material-fitting manner.

A form-fit connection is created by at least two connection partners interlocking or engaging behind each other. In the case of materially bonded connections, the connection partners are held together by atomic or molecular forces. Materially bonded connections are non-detachable connections that can only be separated by destroying the connecting means and/or the connecting partners. Materially bonded can be connected, for example, by adhesive bonding. That is, the stiffening elements may be glued into the deflection sections. Alternatively, the stiffening elements may merely be inserted or clamped into the deflection sections. The stiffening elements may also be connected to the deflection sections in a purely non-positive manner. A frictional connection requires a normal force on the surfaces to be connected to each other. Non-positive connections can be realized by frictional connection.

According to a further embodiment, step a) comprises producing the leaf spring unit as a continuous strand of constant cross-section.

This allows the leaf spring unit to be manufactured cost-effectively in large quantities. Preferably, the leaf spring unit is an integral component, in particular a integral in material component. “Integral” or “one-piece” means in the present case that the leaf spring unit is a continuous component and is not composed of different components. “Integral in material” means in the present case that the leaf spring unit is made throughout from the same material, namely the fiber composite plastic. In the present context, the fact that the cross-section of the leaf spring unit is “constant” means that the cross-section has no bulges, constrictions or the like. In particular, the deflection portions are not reinforced or thickened relative to the leaf spring portions.

According to a further embodiment, step a) comprises producing types of stiffening elements which differ from one another in terms of their properties.

For example, the “properties” may be understood in the present context as the shape or geometry, the stiffness, the modulus of elasticity, the material, the spring constant or the like of the stiffening elements. In particular, the construction kit comprises at least two different types of stiffening elements.

According to a further embodiment, in step c), the stiffening elements are selected in such a way that all the selected stiffening elements belong to the same type of stiffening elements.

That is, identical stiffening elements are attached to the deflection portions of the leaf spring unit. Alternatively, the stiffening elements may be selected such that different types of stiffening elements are attached to a leaf spring unit. This allows further variations in the manufacture of the leaf spring device.

According to a further embodiment, in step a), the stiffening elements are produced in such a way that the stiffening elements have a greater stiffness than the leaf spring unit.

As previously mentioned, the “stiffness” is to be understood as the resistance to elastic deformation, in particular of the respective deflection sections. In particular, with reference to the stiffening elements, their stiffness is to be understood with respect to the stiffness of the respective deflection section. The stiffness can be influenced, for example, by the geometry or a corresponding choice of material of the stiffening elements. For example, the stiffening elements are made of a so-called bulk molding compound (BMC). A BMC is a fiber matrix semi-finished product. However, the stiffening elements may also be made of a metallic or ceramic material, for example. In the event that the stiffening elements have a greater stiffness than the leaf spring unit, the leaf spring sections are bent around the respective stiffening element when a load is applied to the leaf spring device. Preferably, the deflection sections are not deformed in the process.

According to a further embodiment, in step a), the stiffening elements are produced in such a way that the stiffening elements deform elastically when the leaf spring device is loaded.

For example, the stiffening elements may be made of a resin elastomer or rubber. In this case, when the leaf spring device is loaded, the stiffening elements are elastically deformed and pressed out of the respective deflection section at least in sections. In this case, the stiffening elements ensure a uniform stress distribution in the deflection sections so that no compressive stress peaks occur at the inner radii of the deflection sections.

According to a further embodiment, in step a), the stiffening elements are produced from an elastomer.

A resin elastomer or rubber may find application. However, as previously mentioned, the stiffening elements may also be made of a metallic or ceramic material. In this case, however, the stiffening elements do not deform.

According to a further embodiment, in step a), the stiffening elements are produced in such a way that the stiffening elements comprise a core, which has a higher stiffness than the leaf spring unit, and a shell, which surrounds the core at least in sections and has a lower stiffness than the core.

For example, the core is made of a BMC as previously mentioned. The shell, on the other hand, may be made of an elastomer. The core is disposed within the shell. Preferably, the shell completely envelops the core. When a small load is applied to the leaf spring device, initially only the shell is elastically deformed and provides an equal stress distribution in the respective deflection section. In contrast, when the leaf spring device is heavily loaded, the leaf spring sections are bent around the non-deformable core.

Furthermore, a construction kit for manufacturing a leaf spring device made from a fiber composite plastic is proposed. The construction kit comprises a leaf spring unit made from the fiber composite plastic, and a plurality of stiffening elements for locally stiffening the leaf spring unit, wherein the leaf spring unit and a selection of stiffening elements can be combined to form the leaf spring device.

The construction kit is particularly suitable for carrying out the aforementioned method. The construction kit may comprise a plurality of leaf spring units. The leaf spring units may all be identical. However, different types of leaf spring units may also be provided. This increases the number of possible variants in the manufacture of the leaf spring device. In particular, the construction kit comprises a plurality of different types of stiffening elements. All embodiments concerning the construction kit are also applicable to the method and vice versa.

According to one embodiment, the construction kit comprises a plurality of types of stiffening elements which differ from each other in terms of their properties.

As previously mentioned, the stiffening elements may differ from each other, for example, in their geometry or shape. However, the stiffening elements may also differ from each other in the materials used and thus in their material properties.

According to a further embodiment, the stiffening elements have a greater stiffness than the leaf spring unit.

When the stiffness of the stiffening elements is greater than the stiffness of the leaf spring unit, the leaf spring sections bend around the respective stiffening element when the leaf spring device is loaded. However, the stiffening elements may also be elastically deformable. In this case, the stiffening elements initially deform until the leaf spring sections then bend around the stiffening elements.

According to a further embodiment, the stiffening elements comprise a core, which has a higher stiffness than the leaf spring unit, and a shell which surrounds the core at least in sections and has a lower stiffness than the core.

As previously mentioned, the shell may completely enclose the core. The core is preferably made of a BMC. The shell, on the other hand, may be made of an elastomer, for example. In particular, the core is not deformable. The shell, on the other hand, is elastically deformable.

“One” as used herein is not necessarily to be understood as being limited to exactly one element. Rather, multiple elements, such as two, three or more, may also be provided. Also, any other counting word used herein is not to be understood as limiting the number of elements to exactly that number. Rather, numerical variations upward and downward are possible unless otherwise indicated.

Further possible implementations of the method and/or the construction kit also comprise combinations, not explicitly mentioned, of features or embodiments described before or below with respect to the embodiments. In this regard, the skilled person will also add individual aspects as improvements or additions to the respective basic form of the method and/or the construction kit.

Further advantageous embodiments and aspects of the method and/or the construction kit are the subject of the subclaims, as well as the embodiments of the method and/or the construction kit described below. Further, the method and/or the construction kit will be explained in more detail by means of preferred embodiments with reference to the accompanying figures.

### BRIEF DESCRIPTION OF THE DRAWINGS

FIG. 1 shows a schematic view of an embodiment of a leaf spring device;

FIG. 2 shows another schematic view of the leaf spring device according to FIG. 1;

FIG. 3 shows a schematic view of an embodiment of a construction kit for manufacturing the leaf spring device according to FIG. 1;

FIG. 4 shows a schematic partial view of the leaf spring device according to FIG. 1;

FIG. 5 shows a further schematic partial view of the leaf spring device according to FIG. 1;

FIG. 6 shows a further schematic partial view of the leaf spring device according to FIG. 1;

FIG. 7 shows a further schematic partial view of the leaf spring device according to FIG. 1;

FIG. 8 shows a further schematic partial view of the leaf spring device according to FIG. 1;

FIG. 9 shows a further schematic partial view of the leaf spring device according to FIG. 1;

FIG. 10 shows a further schematic partial view of the leaf spring device according to FIG. 1;

FIG. 11 shows a further schematic partial view of the leaf spring device according to FIG. 1;

FIG. 12 shows a further schematic partial view of the leaf spring device according to FIG. 1; and

FIG. 13 shows a schematic block diagram of an embodiment of a method of manufacturing the leaf spring device according to FIG. 1.

In the figures, identical or functionally identical elements have been provided with the same reference signs, unless otherwise indicated.

### DETAILED DESCRIPTION

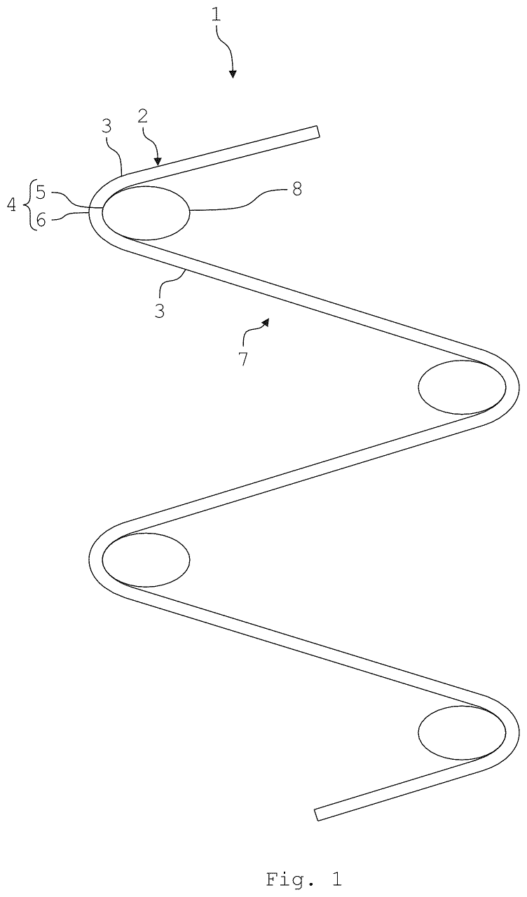

FIG. 1 shows a schematic view of a leaf spring device 1. The leaf spring device 1 is suitable for use on a motor vehicle, in particular on a wheeled vehicle. The leaf spring device 1 can be used in the area of a wheel suspension of the motor vehicle.

The leaf spring device 1 comprises a leaf spring unit 2. The leaf spring unit 2 is made of a fiber reinforced plastic (FRP) material or a fiber composite plastic. The fiber reinforced plastic material comprises a plastic material, in particular a plastic matrix, in which fibers, for example natural fibers, glass fibers, carbon fibers, aramid fibers or the like, are embedded. The plastic material may be a thermoset, such as an epoxy resin. However, the plastic material may also be a thermoplastic. The fibers may be continuous fibers. However, the fibers may also be short or medium length fibers, which may have a fiber length of a few millimeters to a few centimeters. The leaf spring unit 2 may have a layered or laminated structure. For this purpose, for example, layers of fiber fabric or fiber scrim are impregnated with the plastic matrix. Alternatively, however, so-called prepregs, i.e. pre-impregnated fibers, fiber fabrics or fiber webs, can also be used to manufacture the leaf spring unit 2.

The leaf spring unit 2 has a meandering geometry. The leaf spring unit 2 has a plurality of leaf spring sections 3 which are connected to each other at deflection sections 4. The number of leaf spring sections 3 is arbitrary. In FIG. 1, only two leaf spring sections 3 and one deflection section 4 are provided with a reference sign in each case. The individual leaf spring sections 3 can each have an S-shaped geometry or can have an S-shaped course in the side view. Each deflection section 4 has an inner radius 5 and an outer radius 6.

The leaf spring sections 3 can be connected to each other integrally, in particular integrally made of one material, by means of the deflection sections 4. “Integrally” or “one-piece” means in the present case that the leaf spring sections 3 and the deflection sections 4 form a common component and are not composed of different components. “Integrally made of one material” means, in particular, in the present case that the leaf spring sections 3 and the deflection sections 4 are made of the same material throughout. The leaf spring unit 2 is a continuous strand or a continuous strip.

The leaf spring device 1 is preferably designed in such a way that, when the leaf spring device 1 is loaded, no deformation, or at least no appreciable deformation, takes place in the deflection sections 4. The leaf spring sections 3, on the other hand, are each deformed in a central region 7 and generate a spring force counteracting a load acting from the outside.

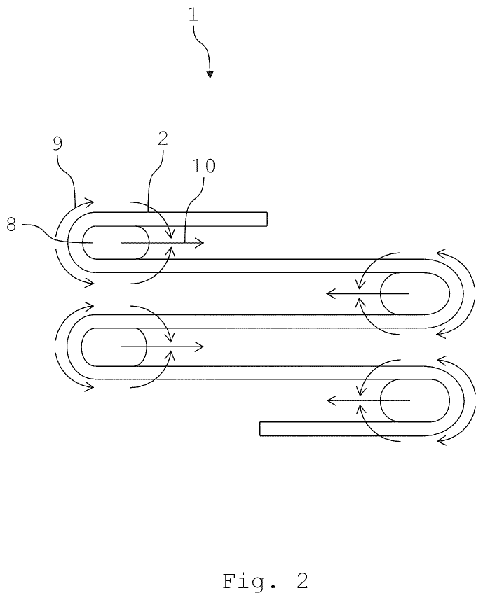

FIG. 1 shows the leaf spring device 1 in an unloaded or deflected state. In contrast, FIG. 2 shows the leaf spring device 1 in a loaded or compressed state. In the compressed state, the leaf spring sections 3, which are S-shaped in the unloaded state, have a planar shape.

In order that the deflection sections 4 do not deform and the leaf spring sections 3 deform substantially only in the regions 7, the leaf spring device 1 has stiffening elements 8, only one of which is provided with a reference sign in FIG. 1. The stiffening elements 8 may also be referred to as insert elements or inserts. The stiffening elements 8 stiffen the leaf spring unit 2 locally at the deflection sections 4, so that the leaf spring unit 2 deforms resiliently substantially only in the regions 7.

The stiffening elements 8 are inserted in selected ones or in all of the deflection sections 4, in particular in the respective inner radius 5 of the deflection sections 4. In this respect, the stiffening elements 8 can be connected to the leaf spring unit 2, for example, in a substance-locking, force-locking and/or form-locking manner. In the case of substance-locking connections, the connecting partners are held together by atomic or molecular forces. Substance-locking connections are non-detachable connections that can only be separated by destroying the connecting means and/or the connecting partners. Materially bonded connections can be made, for example, by adhesive bonding or vulcanization.

A frictional connection requires a normal force on the surfaces to be connected. Non-positive connections can be realized by frictional locking. The mutual displacement of the surfaces is prevented as long as the counterforce caused by the static friction is not exceeded. A form-fit connection is created by at least two connection partners engaging in each other or behind each other. In other words, the stiffening elements 8 can be either releasably or non-releasably connected to the leaf spring unit 2.

With the aid of the stiffening elements 8, the stressability of the leaf spring unit 2 can be increased by achieving an optimized distribution of compressive stress. Form-related weak points, namely in particular the inner radius 5 of the deflection sections 4, of the leaf spring concept, which can lead to material-critical compressive stresses at the inner radius 5, are compensated. In this way, the material-given potential of the fiber composite plastic can also be fully exploited, in that the deformation energy is brought to bear in the leaf spring sections 3 which are less critical to stress.

Several effects are used for this purpose. On the one hand, the leaf spring sections 3 roll on the respective stiffening element 8 and thus a controlled relative deformation of the deflection sections 4 and a controlled build-up of compressive stress in the deflection sections 4 takes place. This rolling is indicated in FIG. 2 with the aid of arrows 9. The mode of operation of the stiffening elements 8 can thereby be compared with the mode of operation of a deflection pulley.

Additionally or alternatively, a compression of the respective stiffening element 8 or elements 8 occurs. This compression or deformation is indicated in FIG. 2 by means of an arrow 10. In this case, the stiffening elements 8 are made of an elastomer, for example. This compression generates a stress which reduces the deformation of the leaf spring unit 2 in the critical deflection sections 4, thus also leading to a more uniform distribution of compressive stress. In particular, the stiffening element 8 distributes stresses evenly so that stress peaks are prevented or at least reduced. Thus, critical compressive stress peaks at the respective inner radius 5 of the deflection sections 4 are prevented with the aid of the stiffening elements 8.

The material-specific advantages of the anisotropic fiber composite plastic can be fully exploited by the concept of combining the leaf spring unit 2 with the stiffening elements 8, since the possible total load of the leaf spring device 1 can be increased by the design-related energy displacement into the leaf spring sections 3, in particular into the regions 7.

Furthermore, by incorporating the stiffening elements 8 into or onto the prefabricated leaf spring unit 2, an economical manufacturing process can be run. In contrast to springs with a laminated core, a continuous draping process can be carried out during the manufacture of the leaf spring unit 2. A laminating-in of the stiffening elements 8 can be dispensed with. By avoiding an interruption of the process and by a reduced introduction of porosity by a laminated core itself or by discontinuous areas which could cause air pockets in case of over-draping, a quality improvement can be achieved.

Furthermore, by omitting a core in the form of a stiffening element 8, a more ordered fiber profile can be achieved, since the core is not pressed in and cured in a pressing process, which could lead to shifts in the fiber profile, in particular to increased resin accumulation at the outer radii 6 of the deflection sections 4. This leads to an improvement in quality as well as in repeatability.

Furthermore, the concept of combining the leaf spring unit 2 with the stiffening elements 8 also opens up the possibility of adapting the spring characteristics of the leaf spring device 1. This can be carried out in a process step downstream of the manufacture of the leaf spring unit 2 by means of an easily adaptable stiffening of the deflection sections 4 with the aid of an insertion of the stiffening elements 8.

For example, independently of an always identical already cured strand-shaped and unidirectional leaf spring unit 2, which can always be manufactured with the same tool, leaf spring devices 1 with approximately the same cross-section can easily be manufactured here with the most varied properties by inserting the most varied stiffening elements 8, which differ from one another, for example, in their shape, size, material or the like. Since the stiffening element 8 or the stiffening elements 8 can be subsequently inserted from the outside independently of the manufacturing process of the leaf spring unit 2, the draping and curing process is decoupled from the properties of the leaf spring device 1 to be set. This leads to a high flexibility in the manufacturing of the leaf spring device 1.

By combining the prefabricated leaf spring unit 2 with the subsequently inserted stiffening elements 8, an optimized utilization of the material-specific performance of the fiber composite plastic can be achieved, which is due to the concept. This is due to the fact that the special structure and design of the leaf spring device 1, in particular of the stiffening elements 8 and the physical operating principle thereof, compensates for the material-specific weak points at the deflection sections 4 and thus the energy absorption of the leaf spring device 1 can be significantly optimized.

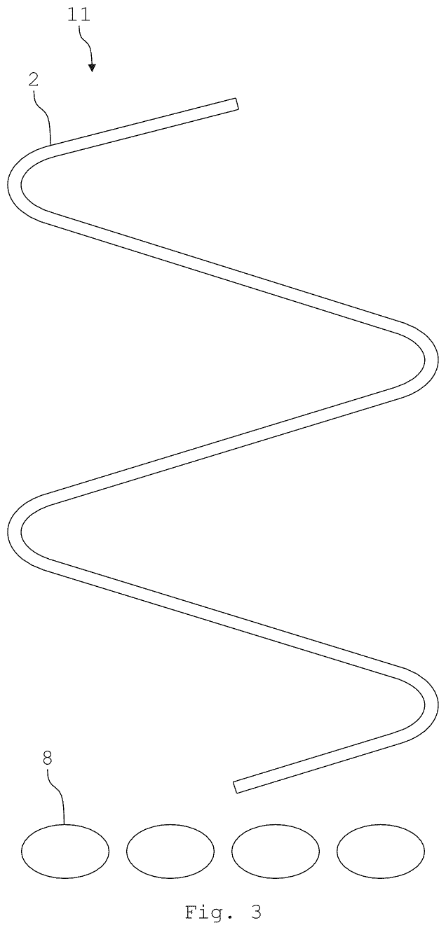

FIG. 3 shows a schematic view of a construction kit 11, which can be used for manufacturing a leaf spring device 1 as previously described. The construction kit 11 comprises at least one leaf spring unit 2 as previously explained, as well as a plurality of stiffening elements 8. In this respect, the construction kit 11 comprises any number of different types or kinds of stiffening elements 8. The types of stiffening elements 8 may, for example, differ from each other in their stiffness, shape, size, material or the like.

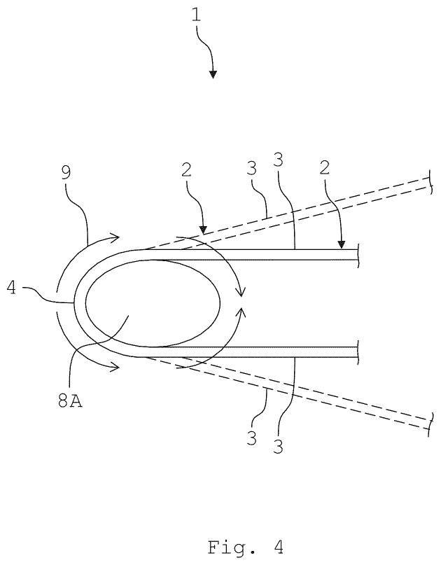

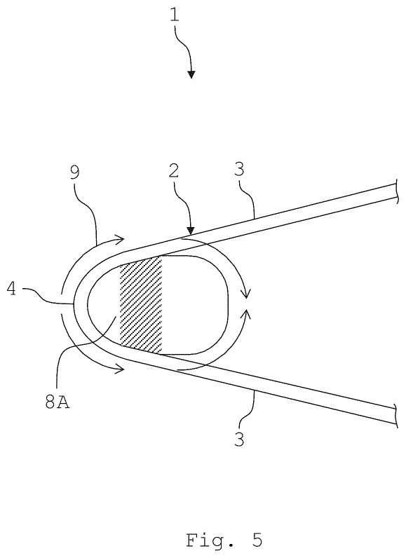

FIGS. 4 and 5 each show schematic partial views of the leaf spring device 1 with a further embodiment of a stiffening element 8A. The stiffening element 8A is made of an incompressible material, such as a so-called bulk molding compound (BMC). A BMC is a fiber matrix semi-finished product. It most commonly comprises short glass fibers and a polyester or vinyl ester resin, but other reinforcing fibers or resin systems are possible. However, the stiffening element 8A may also be made of a metallic or ceramic material.

FIG. 4 shows the leaf spring device 1 under a high load. Here, in FIG. 4, the leaf spring sections 3 are shown with dashed lines in the deflected or unloaded state of the leaf spring device 1. In the compressed or loaded state, the leaf spring sections 3 are shown with solid lines. The leaf spring sections 3 bend around the stiffening element 8A when the leaf spring device 1 is loaded. In contrast, FIG. 5 shows the leaf spring device 1 in a low loading state. In the light loading state, the leaf spring sections 3 deform slightly and are bent slightly around the stiffening element 8A.

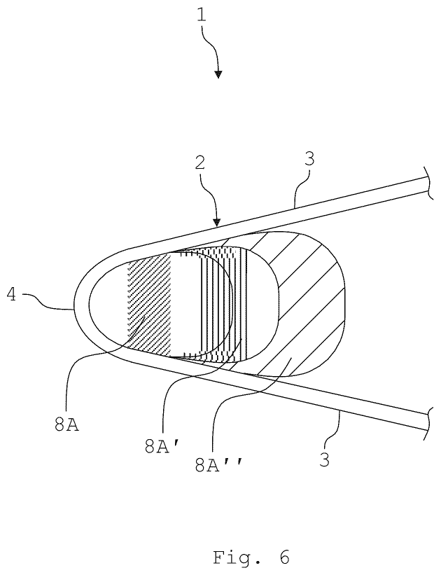

FIG. 6 shows how the properties of the leaf spring device 1 can be influenced. For this purpose, different types of stiffening elements 8A, 8A′, 8A″ are provided, which differ from each other in their shape and geometry, respectively. For example, a greater stiffening of the deflection section 4 can be achieved with the aid of the stiffening element 8A″ than with the aid of the stiffening element 8A.

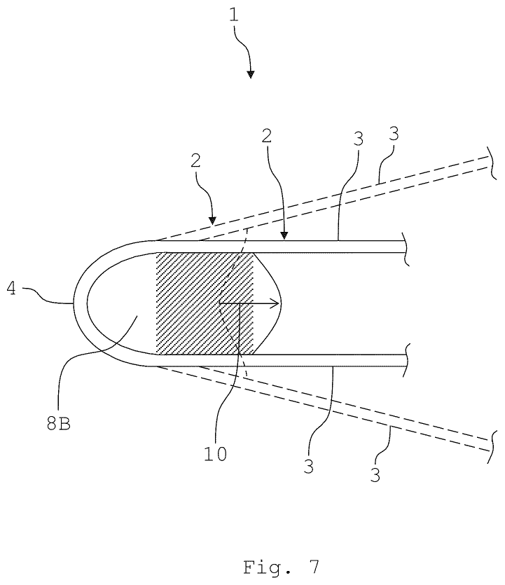

FIGS. 7 to 9 each show schematic partial views of the leaf spring device 1 with a further embodiment of a stiffening element 8B. In contrast to the stiffening element 8A, the stiffening element 8B is elastically deformable. For example, the stiffening element 8B may be made of an elastomer, in particular a resin elastomer. For example, the stiffening element 8B may also be made of rubber.

FIG. 7 shows the leaf spring device 1 under a high load. Here, in FIG. 7, the leaf spring sections 3 are shown with dashed lines in the deflected or unloaded state of the leaf spring device 1. In the compressed or loaded state, the leaf spring sections 3 are shown with solid lines. The leaf spring sections 3 deform elastically, but do not bend around the deformable stiffening element 8B when the leaf spring device 1 is loaded, but the stiffening element 8B itself is elastically deformed.

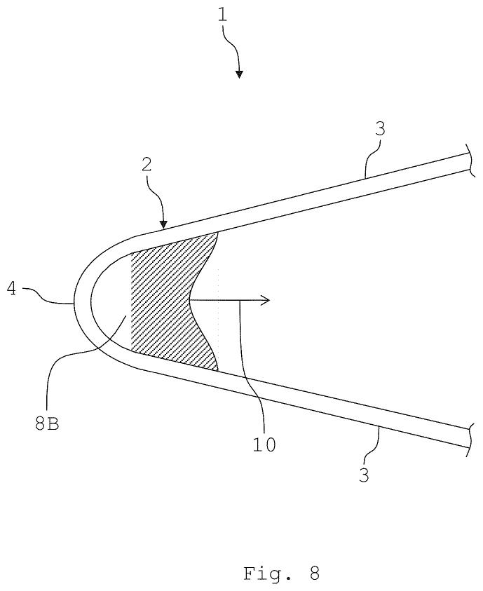

The deformed stiffening element 8B provides a uniform stress distribution in the respective deflection section 4. In the deflected state of the leaf spring device 1, an outer contour of the stiffening element 8B is shown with a dashed line in FIG. 7. In the compressed state, the outer contour of the stiffening element 8B is shown with a solid line. In contrast, FIG. 8 shows the leaf spring device 1 in a low load state. In the low load state, the leaf spring sections 3 deform slightly. The stiffening element 8B itself is elastically deformed.

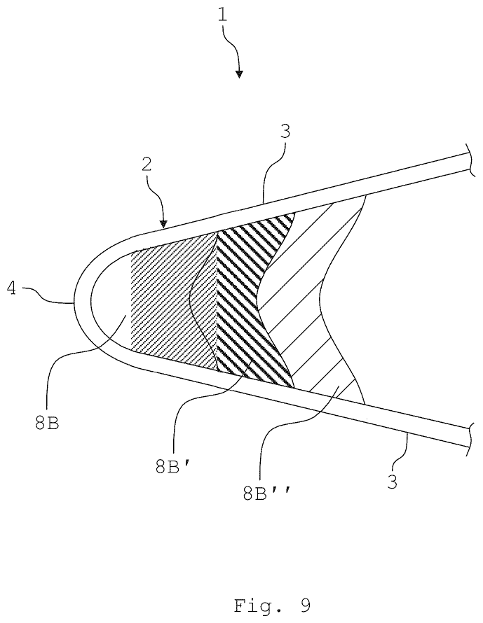

FIG. 9 shows how the properties of the leaf spring device 1 can be influenced. For this purpose, different types of stiffening elements 8B, 8B′, 8B″ are provided, which differ from each other in their shape and geometry, respectively. For example, a greater stiffening of the deflection section 4 can be achieved with the aid of the stiffening element 8B″ than with the aid of the stiffening element 8B.

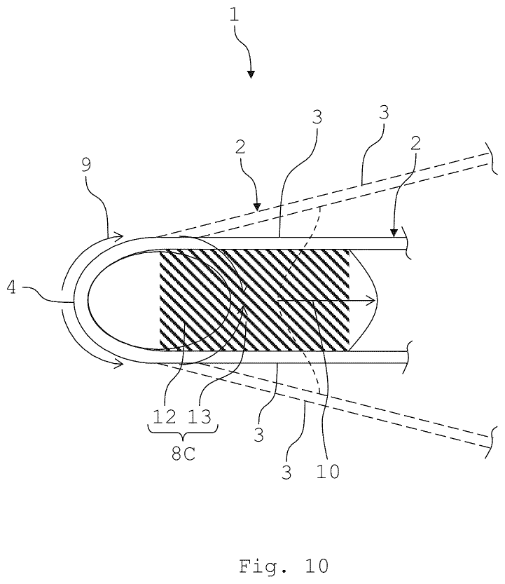

FIGS. 10 to 12 each show schematic partial views of the leaf spring device 1 with a further embodiment of a stiffening element 8C. The properties of the stiffening element 8C result from a combination of the properties of the previously explained stiffening elements 8A, 8A′, 8A″, 8B, 8B′, 8B″. The stiffening element 8C is a composite or composite material element. The stiffening element 8C comprises an incompressible core 12 made of a BMC, for example, and a shell 13 encasing the core 12. The shell 13 may be made of an elastomer.

FIG. 10 shows the leaf spring device 1 under a high load. Here, in FIG. 10, the leaf spring sections 3 are shown with dashed lines in the deflected or unloaded state of the leaf spring device 1. In the compressed or loaded state, the leaf spring sections 3 are shown with solid lines. The leaf spring sections 3 bend around the stiffening element 8C, in particular around the core 12, when the leaf spring device 1 is loaded. At the same time, the shell 13 deforms elastically.

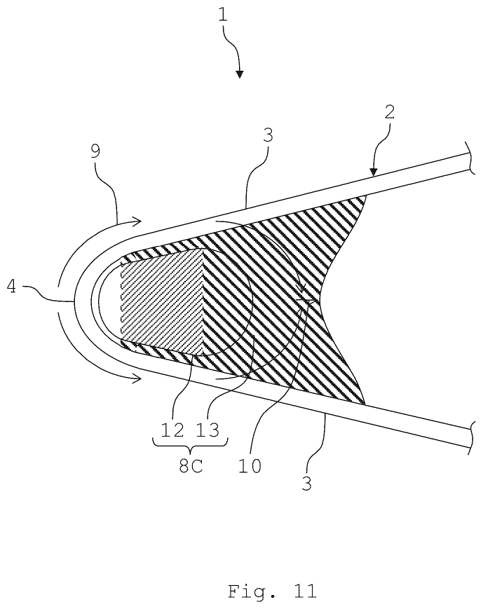

In the deflected state of the leaf spring device 1, an outer contour of the shell 13 is shown with a dashed line in FIG. 10. In the compressed state, the outer contour of the shell 13 is shown with a solid line. In contrast, FIG. 11 shows the leaf spring device 1 in a low load condition. In the low load condition, the leaf spring sections 3 deform slightly and are bent slightly around the core 12. At the same time, the shell 13 is also elastically deformed.

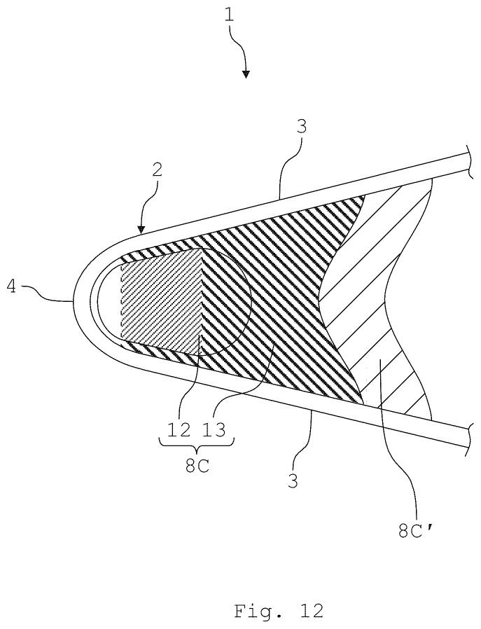

FIG. 12 shows how the properties of the leaf spring device 1 can be influenced. For this purpose, different types of stiffening elements 8C, 8C′ are provided, which differ from each other in that their shells 13 have different geometries and/or material properties. For example, a greater stiffening of the deflection section 4 can be achieved with the aid of the stiffening element 8C′ than with the stiffening element 8C.

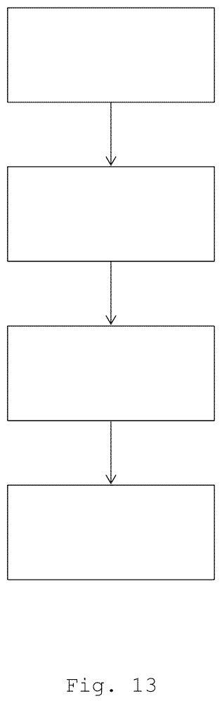

FIG. 13 shows a schematic block diagram of an embodiment of a method for manufacturing the leaf spring device 1. In the method, in a step S1, the construction kit 11 comprising the leaf spring unit 2 made of the fiber composite plastic and a plurality of stiffening elements 8, 8A, 8A′, 8A″, 8B, 8B′, 8B″, 8C, 8C′ for locally stiffening the leaf spring unit 2 is provided.

Providing the construction kit 11 may include fabricating the leaf spring unit 2 and the stiffening elements 8, 8A, 8A′, 8A″, 8B, 8B′, 8B″, 8C, 8C′. In this regard, different types or kinds of leaf spring units 2 and/or stiffening elements 8, 8A, 8A′, 8A″, 8B, 8B′, 8B″, 8C, 8C′ may be manufactured.

In a step S2, the leaf spring device 1 is designed according to a desired use case. The use case may be, for example, a particular configuration of a vehicle platform. The design may be performed with the aid of a computer program. During the design, for example, the spring constant and/or the dimensions of the leaf spring device 1 are determined.

In a step S3, stiffening elements 8, 8A, 8A′, 8A″, 8B, 8B′, 8B″, 8C, 8C′ are selected from the construction kit 11 according to the design of the leaf spring device 1. In a subsequent step S4, the selected stiffening elements 8, 8A, 8A′, 8A″, 8B, 8B′, 8B″, 8C, 8C′ and the leaf spring unit 2 are assembled or combined to form the leaf spring device 1. In this regard, the stiffening elements 8, 8A, 8A′, 8A″, 8B, 8B′, 8B″, 8C, 8C′ may be bonded to the leaf spring unit 2, for example.

Although the present invention has been described with reference to examples of embodiments, it can be modified in a variety of ways.

### LIST OF REFERENCE SIGNS

1 Leaf spring device
2 Leaf spring unit
3 Leaf spring section
4 Deflection section
5 Inner radius
6 Outer radius
7 Region
8 Stiffening element
8A Stiffening element
8A′ Stiffening element
8A″ Stiffening element
8B Stiffening element
8B′ Stiffening element
8B″ Stiffening element
8C Stiffening element
8C′ Stiffening element
9 Arrow
10 Arrow
11 Construction kit
12 Core
13 Shell
S1 Step
S2 Step
S3 Step
S4 Step

1. A method for manufacturing a leaf spring device made from a fiber composite plastic, comprising the following steps:
a) providing a construction kit comprising a leaf spring unit made from the fiber composite plastic and a plurality of stiffening elements for locally stiffening the leaf spring unit;
b) designing the leaf spring device according to a desired application;
c) selecting stiffening elements from the construction kit according to the design of the leaf spring device; and
d) combining the selected stiffening elements and the leaf spring unit to form the leaf spring device.

2. The method according to claim 1, characterized in that in step d), the selected stiffening elements are attached to deflection sections of the leaf spring unit.

3. The method according to claim 2, characterized in that in step d), the selected stiffening elements are attached to a respective inner radius of the deflection sections.

4. The method according to claim 2, characterized in that in step d), the selected stiffening elements are connected to the deflection sections in a form-fitting and/or material-fitting manner.

5. The method according to claim 1, characterized in that step a) comprises producing the leaf spring unit as a continuous strand of constant cross-section.

6. The method according to claim 1, characterized in that step a) comprises producing types of stiffening elements which differ from one another in terms of their properties.

7. The method according to claim 6, characterized in that in step c), the stiffening elements are selected in such a way that all the selected stiffening elements belong to the same type of stiffening elements.

8. The method according to claim 6, characterized in that in step a), the stiffening elements are produced in such a way that the stiffening elements have a greater stiffness than the leaf spring unit.

9. The method according to claim 6, characterized in that in step a), the stiffening elements are produced in such a way that the stiffening elements deform elastically when the leaf spring device is loaded.

10. The method according to claim 9, characterized in that in step a), the stiffening elements are produced from an elastomer.

11. The method according to claim 6, characterized in that in step a), the stiffening elements are produced in such a way that the stiffening elements comprise a core, which has a higher stiffness than the leaf spring unit, and a shell, which surrounds the core at least in sections and has a lower stiffness than the core.

12. A construction kit for manufacturing a leaf spring device made from a fiber composite plastic, comprising:
a leaf spring unit made from the fiber composite plastic; and
a plurality of stiffening elements for locally stiffening the leaf spring unit;
wherein the leaf spring unit and a selection of stiffening elements can be combined to form the leaf spring device.

13. The construction kit according to claim 12, characterized by a plurality of types of stiffening elements which differ from each other in terms of their properties.

14. The construction kit according to claim 12, characterized in that the stiffening elements have a greater stiffness than the leaf spring unit.

15. The construction kit according to claim 12, characterized in that the stiffening elements comprise a core, which has a higher stiffness than the leaf spring unit, and a shell, which surrounds the core at least in sections and has a lower stiffness than the core.
